(19) United States
(12) Patent Application Publication
(10) Pub. No.: US 2014/0145095 A1
(43) Pub. Date: May 29, 2014

(54) METHOD AND APPARATUS FOR DIPOLAR DC COLLISIONAL ACTIVATION OF IONS TRANSMITTED THROUGH AN ELECTRODYNAMIC MULTIPOLE DEVICE

(71) Applicant: PURDUE RESEARCH FOUNDATION, West Lafayette, IN (US)

(72) Inventors: Scott A. McLuckey, West Lafayette, IN (US); Ian K. Webb, Lafayette, IN (US)

(21) Appl. No.: 14/118,794

(22) PCT Filed: Jun. 14, 2012
(86) PCT No.: PCT/US2012/042384

§ 371 Date: Jan. 30, 2014

Related U.S. Application Data
(60) Provisional application No. 61/497,246, filed on Jun. 15, 2011.

(51) Int. Cl. H01J 49/00

(52) U.S. Cl. CPC H01J 49/0031
USPC 250/489

(57) ABSTRACT

A method of operating a quadrupole mass spectrometer is described where one of the stages thereof has a pairs of opposing rods and one of the pair of rods is operated with a zero voltage potential difference therebetween and the other of the pair of opposing rods is operated with a voltage potential difference therebetween. The potential field unbalance causes the analyte ions to deviate from the axial centerline of the stage so as to undergo additional RF heating. The stage is operated in a transmission mode and the resultant reaction products may be further processed in subsequent stages or output to a mass spectrometer.

This application claims the benefit of U.S. provisional application U.S. 61/497,246 filed on Jun. 15, 2011, which is incorporated herein by reference.

### BACKGROUND

Fragmentation methods have been extensively used for the elucidation of the structural features of ions by analytical tandem mass spectrometry. Collision-induced dissociation (CID), can be implemented over a wide range of conditions, and is widely used in small molecule analysis, proteomics, and genomics. CID has been used in small molecule and drug analysis for drug and drug metabolite identification in clinical samples as well as forensic and drug-screening applications. CID is also used to characterize peptides resulting from enzymatic or chemical cleavage in a “bottom-up” approach. Whole protein analysis may be performed by CID in a “top-down” approach, where an intact protein is fragmented by CID or another activation technique. CID has also been used in “bottom-up” and “top-down” genomics, fragmenting oligonucleotides as well as whole RNAs.

CID is effected by exposing accelerated ions to collisions with neutral target gases that are essentially at rest. An ion trap CID uses a single dipolar AC signal in resonance with a fundamental secular frequency of the ion of interest to accelerate the ion in the presence of a bath of gas, which serves as the collisional target. In beam-type CID as employed, for example, in a triple quadrupole MS/MS experiment, ions are injected into a bath gas present in a collision cell after accelerating the ions through a potential gradient field. One of several differences between ion-trap type CID and beam-type CID is that ion acceleration in the former is mass-selective whereas in the latter it is not. Examples of other non-mass-selective activation methods include surface-induced dissociation (SID), which occurs when ions collide with a metal or non-conducting surface, and infrared multiphoton dissociation (IRMPD), a method that uses multiple low-energy IR photons to vibrationally excite and dissociate ions, but with a dependence on the ability to absorb IR photons. Methods for providing broadband ion acceleration for ion trap CID include the use of broad-band acceleration waveforms and the application of a low frequency AC voltage to the ion trap end-cap electrodes.

A broadband ion trap CID method, termed DDC CID, was recently described to provide for non-mass-selective collisional activation by application of a dipolar DC potential across a pair of opposing electrodes in a linear ion trap in conjunction with a Fourier transform ion cyclotron resonance mass spectrometer.

### SUMMARY

An apparatus and method for effecting dipolar DC (DDC) collisional activation (CID) of ions transmitted through a quadrupole array of a quadrupole/time-of-flight mass spectrometer for the broadband dissociation of a wide range of analyte ions is disclosed. Transmission mode DDC activation induces simultaneous fragmentation of ions in a wide mass-to-charge range. A dipolar DC potential may be applied across a pair of opposing rods in a quadruple collision cell of a QqTOF (quadrupole/time-of-flight) hybrid mass spectrometer to effect fragmentation.

In experimental examples, ions derived from a small drug molecule and a model peptide were injected into the collision cell where the ions were subjected to a DDC field, in addition to the usual RF field used to confine ion motion in the x-y plane. The DDC field displaces the transmitted ions from the axial center line of the quadrupole array where they then undergo acceleration due to the RF field (RF heating). The DDC CID method is a readily tunable tool for probing structural information of analyte ions without trapping the ions. The DDC CID method provides a means for collisional activation in beam-type instruments that is independent of the kinetic energy of the ions in the axial (z) dimension.

The dipolar DC applied to opposing rods in a gas-filled quadrupolar array in a transmission mode effects the collisional activation. Relatively high dissociation rates have been achieved for the polyatomic ions studied to date. The implementation of a transmission mode tandem mass spectrometry experiment with protonated bromocriptine and protonated leucine enkephalin is disclosed. The salient experimental variables are the DDC amplitude, the amplitude of the drive RF, and the activation period. The generality of the method and characteristics for collisional activation (e.g., tuning conditions, activation of first- and higher generation product ions) make it a useful technique that complements the single-frequency resonance excitation technique commonly used with electrodynamic ion traps, trapping DDC activation, and beam-type activation techniques.

### BRIEF DESCRIPTION OF THE DRAWINGS

FIG. 1A is a schematic side cross sectional representation of a quadrupole QqTOF instrument; and (B) is a cross section of the Q2 stage, transverse to the rod axis showing modifications to the voltage application in the Q2 stage to perform a DDC experiment;

FIG. 2 shows experimental results for a transmission-mode product ion spectrum of protonated YGGFL using V_{DDC}=16 V and V_{RF}=407 V;

FIG. 3 shows experimental results for a trapping-mode product ion spectrum of protonated YGGFL using VDDC=14 V and VRF=407 V, 180 ms activation time; and

FIG. 4 shows experimental product ion spectra of protonated bromocriptine in (A) trapping mode DC CID, 40 VDDC, VRF=611 V, 7.5 ms; (B) trapping mode AC CID, 500 mVpp, lmco=117 (VRE=611 V), 7.5 ms; and, (C) transmission-mode DDC, 28 VDDC, VRF=611 V.

### DESCRIPTION

Exemplary embodiments may be better understood with reference to the drawings, but these embodiments are not intended to be of a limiting nature. In the following description, numerous specific details are set forth in the examples in order to provide a thorough understanding of the subject matter of the claims which, however, may be practiced without some or all of these specific details. When a specific feature, structure, or characteristic is described in connection with an example, it will be understood that one skilled in the art may effect such feature, structure, or characteristic in connection with other examples, whether or not explicitly stated herein. In other instances, well known process operations have not been described in detail in order not to unnecessarily obscure the description.

DDC CID is a broad-band activation technique, having characteristics that may be analogous to IRMPD, but with using a laser energy source. The present approach has been evaluated on a tandem MS platform (viz., a quadrupole/time-of flight (TOF) platform) that employs a quadrupole collision cell or QqTOF stage. The use of a relatively fast TOF mass analyzer permits operation of DDC CID in a transmission-mode configuration. Collisional activation in transmission-mode tandem mass spectrometry is dependent upon the translational energy of the precursor ions that are injected into the collision cell.

A transmission mode CID apparatus using DDC activation may allow decoupling of the precursor ion injection energy from the internal energy distribution generated by collisional activation in the collision cell. An application of transmission mode DDC CID is shown herein for ions derived from small drug molecule and peptide models.

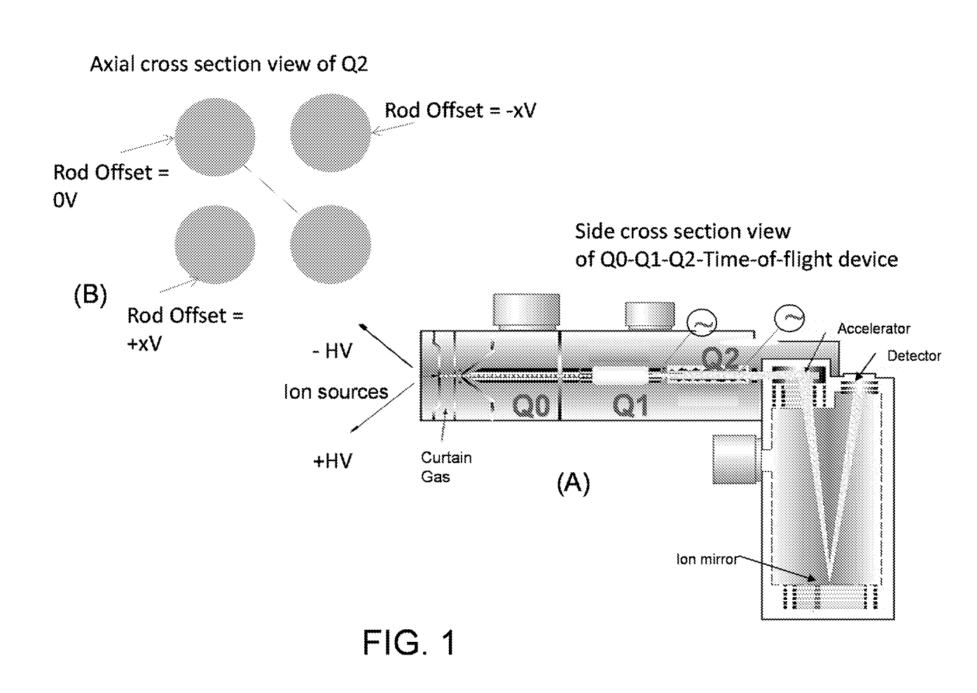

The experimental QqTOF apparatus is shown in FIG. 1. The transmission mode experiments performed mass selection using Q1 with a continuous transmission of precursor and product ions into the TOF section.

For comparison, the apparatus was also configured to perform a typical scan involving ion storage: injecting ions into Q2 for 100 ms, cooling the ions and ramping the DC dipolar voltage (30 ms), activating the ions in the presence of the field in Q2 (variable time), cooling the ions with the DC dipolar removed (50 ms, and ejecting the ions into the TOF region for mass analysis (50 ms). The ramping time was used to make sure that the rod voltage offsets reached the voltages set in the software.

Tolmachev et al., “Collisional Activation in RF Ion Traps and Guides,” J Am Soc Mass Spectrom 2004, 15, 1616-1628, have described an effective-ion-temperature model applicable to collisional activation of ions in electrodynamic ion traps and provided experimental results from DDC CID in a linear ion trap coupled with periodic ejection of analyte ions into an ion cyclotron resonance mass spectrometer.

The approximate change in temperature of an ion population exposed to DDC excitation for a heavy ion/light target case was given as:

$$Δ {T}_{K} = \frac{{m}_{g} {Ω}^{2} {r}_{0}^{2}}{24 k} {( \frac{{V}_{DDC}}{{V}_{RF}} )}^{2} \qquad ( 1 )$$

where m_{g} is the mass of the target gas, Ω is the drive angular frequency of the LIT, r₀ is the inscribed radius of the quadrupole, k is the Boltzmann constant, V_{DDC} is the magnitude of the applied dipolar DC voltage, and V_{RF} is the 0-to peak amplitude of the drive RF voltage. This relationship suggests that the change in ion internal temperature is independent of ion mass and charge, is directly related to the square of the V_{DDC}, and inversely related to the square of the V_{RF}. The motions of ions in ion traps can be separated into the secular component, which is mass-to-charge dependent, and the RF ripple component.

Collisional activation takes place via “RF heating” as the ions displaced from the trap axial center line into regions of higher RF potential undergo greater amplitude RF ripple (or micro-motion). The average ion velocities are thereby increased, which results in more energetic collisions with the bath gas. The average displacement of the ion from the center of the device, rₑ, may be approximated by:

$${r}_{e} = \frac{{r}_{0}}{q} \frac{{V}_{DDL}}{{V}_{RF}} \qquad ( 2 )$$

where qᵤ is the well-known Mathieu parameter in dimension u (x or y for the quadrupole) given by:

$${q}_{u} = \frac{4 {zeV}_{RF}}{{mr}_{e}^{2} {Ω}^{2}} \qquad ( 3 )$$

As the qᵤ parameter is inversely related to mass-to-charge for a fixed value of V, rₑ is directly related to mass-to-charge (i.e., higher m/z ions are displaced more than lower m/z ions). This introduces an upper m/z limit in the V_{DDC} experiment. This limit can be estimated by determining the point at which rₑ reaches r₀

$${( \frac{m}{z} )}_{high} = \frac{4 e}{{r}_{0}^{2} {Ω}^{2}} \frac{{V}_{RF}^{2}}{{V}_{DDC}} \qquad ( 4 )$$

A low m/z limit associated with the DDC experiment herein can be calculated in the usual way by determining the mass-to-charge value of the ion at which qᵤ=0.908.

As the DDC technique involves dissociation taking place at the same time as continuous ion activation, the process may be thought of as a “slow heating” method. As such, the precursor ion population may achieve a steady-state internal energy distribution following a transition period from the pre-activation internal energy distribution. The steady-state internal energy distribution of the activated ion population may be approximated by a temperature if the rate-determining step is a process of fragmentation from the high-energy tail of the distribution (that is, a rapid energy-exchange regime or high-pressure regime). The effective temperature under these conditions may be approximated by:

T_{eff}=T_{bath gas}+ΔT_{K} (5)

When the rate determining step is passage over the energy barrier to dissociation (that is, a slow energy-exchange regime), the activated ion population may be characterized by a truncated Boltzmann distribution and may not be well described by a temperature value. In either case, for a precursor-ion population characterized by a single pair of activation energy and entropy, a single dissociation rate, k_{diss}, is associated with each set of activation conditions and higher k_{diss} values result from more-highly-activated ions. The measurement of k_{diss}, which is obtained from the slope of the plot of—ln [M+H]⁺ₜ/[M+H]⁺₀ vs. time, provides a means for assessing the energy transferred to the precursor ion population as a function of experimental conditions. Provided there are no ion losses, [M+H]⁺₀ may be approximated, for example, from a product-ion spectrum by the sum of the abundances of all product ions and residual precursor ion (viz., Σ([M+H]⁺ₜ+product ions)).

For a specified quadrupole radius and drive frequency, experimental parameters for DDC collisional activation, as shown in equation (1), include V_{DDC}, V_{RF}, and the mass of the target gas. Note that bath gas pressure may not be a significant factor in determining ΔT_{K}, provided that the collision frequency is significantly lower than the frequency of the micro-motion, as is the case for ion traps operated in the MHz range and at background pressures on the order of 10 mtorr and below. However, pressure may be expected to be a factor in determining the time required to reach a steady-state internal energy condition.

The DDC approach permits varying the collision energy independently of the precursor ion injection energy, which may be useful from the standpoint of ion transmission and/or structural information content. Data was collected in a purely transmission mode condition (that is, no ion-trapping step) whereby precursor ions were mass selected via Q1 and injected into Q2 at translational energies insufficient to cause measureable CID (e.g., 5 eV) while simultaneously supplying a dipolar DC (DDC) potential to an opposing pair of rods in Q2. Products that exited from Q2 were continuously transmitted to the TOF for mass analysis.

Experiments were performed using a modified QqTOF (QStar XL, AB Sciex, Concord, ON, CA). The instrument geometry is comprised of a transmission quadrupole operated in RF-only mode, a mass resolving quadrupole, and a quadrupole collision cell. The designations for these quadrupoles are Q0, Q1, and Q2, respectively.

The apparatus was modified to allow for the application of DC dipolar potentials across a pair of opposing rods in both the Q0 and Q2 quadrupoles, as shown in FIG. 1. The rod voltage offset leads to one pair of diametrically opposed rods were unpaired, while the other rod pair remained paired. The DC offset for each uncoupled rod was supplied by individual power supplies, and another power supply provided the offset for the remaining pair. Other power supply configurations may be used to achieve this result. This arrangement allowed an offset voltage D_{DDC} of to be applied between an opposing pair of rods (e.g., +/−x), while the offset voltage between the other opposing pair of rods was zero.

Instrument control was provided by Dactalyst 3.14 software, developed by AB Sciex. The instrument voltages were controlled through the Daetalyst software. The experiments described herein used DDC potentials in Q2 section only. However, ions may also be heated by prior to mass selection in Q0. Heating of the ions in Q0 may be useful in suppressing loosely bound complexes formed in the ion source. The parameters for Q2 operation were r₀=4.17 mm and Ω=1.8 MHz and V_{RF} (listed as 0-peak) and the V_{DDC} values are given below. The background gas pressure was 2×10⁻⁵ torr for all experiments unless otherwise noted.

Precursor ions were selected via RF/DC isolation in Q1. Auxiliary AC potentials were applied to the entrance and exit lenses of Q2 at frequencies of 250 kHz and 500 V p-p to provide efficient trapping during the DDC CID activation segment when operating the instrument in storage mode for comparison purposes. The transmission mode experiments employed DC voltages applied to the entrance and exit lenses of Q2 and having values that allowed ions to be transmitted through Q2 and into the TOF region.

Bromocriptine and leucine enkephalin acetate salt hydrate were purchased from Sigma-Aldrich (St. Louis, Mo.). Methanol and glacial acetic acid were purchased from Avantor, Inc. (Phillipsburg, N.J.). Bromocriptine was prepared in a 67 μM aqueous solution. Leucine enkephalin was prepared in a 25 μM 50/50/1 water/methanol/acetic acid solution and bovine ubiquitin was prepared in a 12 μM concentration in a 50/50/1 water/methanol/acetic acid solution. Samples were used without further purification.

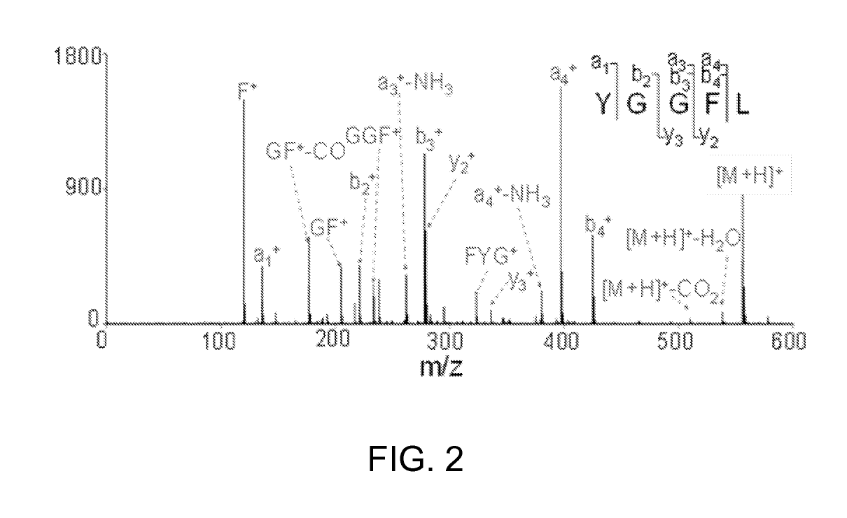

FIG. 2 shows the results obtained using V_{DDL}=16 V and V_{RF}=407 V. The DDC approach heats the ions rapidly enough to give rise to a significant degree of observed fragmentation. Efficient transmission of the products to the TOF analyzer should be considered as the DDC moves the ions off of the device central axis and may result in poor coupling with downstream device elements. Equation (2) predicts an average displacement of 1.3 mm for the precursor ions under the stated experimental conditions. However, experientially, there did not appear to be a significant loss in total ion signal when the DDC voltage was imposed. At least for the conditions of the experiment performed, there appears to be little sacrifice in ion transmission efficiency due to the offset.

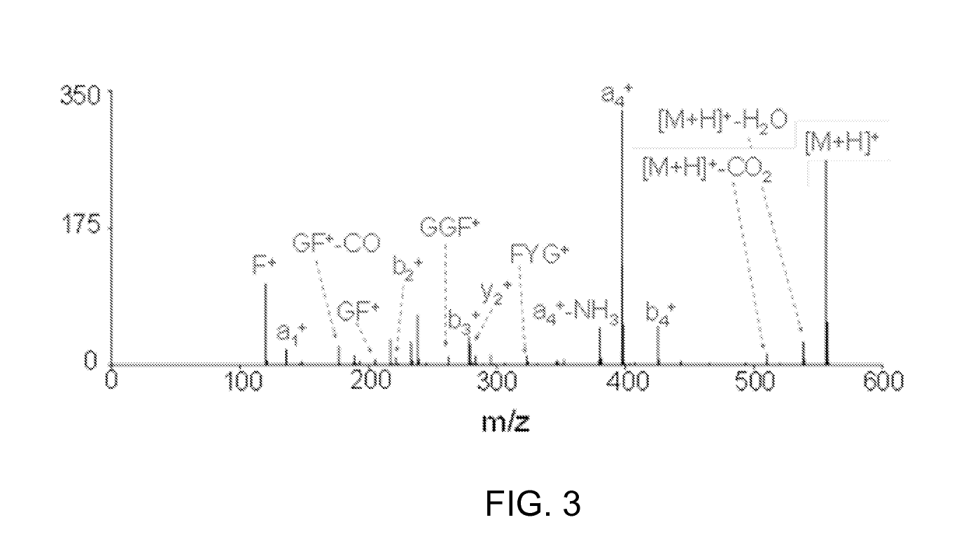

FIG. 3 shows a trapping experiment with V_{DDC}=14 V and V_{RF}=407 V with an activation time of 108 ms. Similar product ions are generated by both methods.

The transmission-mode DDC method and apparatus is not restricted to TOF mass analysis and could be implemented, for example, with a triple quadrupole instrument where the ion acceptance area for the mass analyzer can be larger than that of the TOF analyzer. A gas-filled RF-only section following the collision cell and prior to the mass analyzer may be used to re-center the ion beam for injection into the mass analyzer. Hence, the off-axis displacement associated with the DDC field need not be a consideration for subsequent effective injection into a mass analyzer.

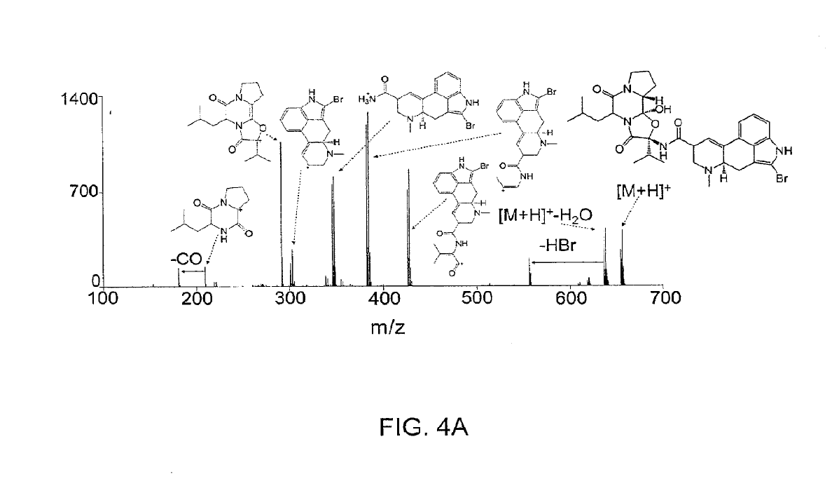

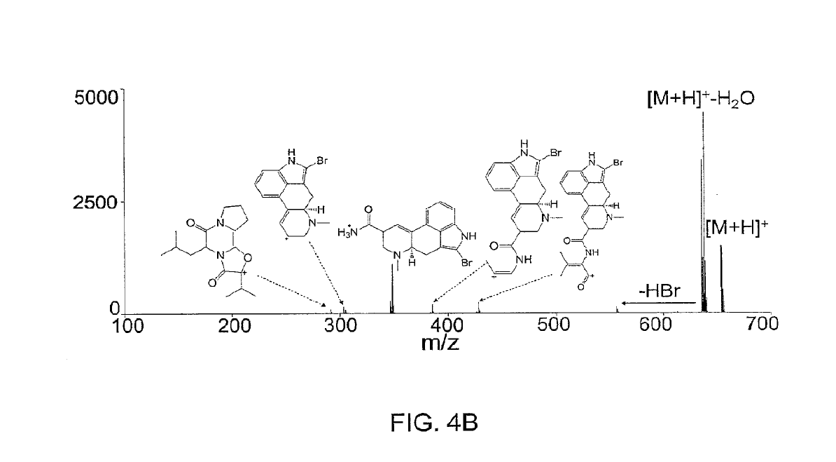

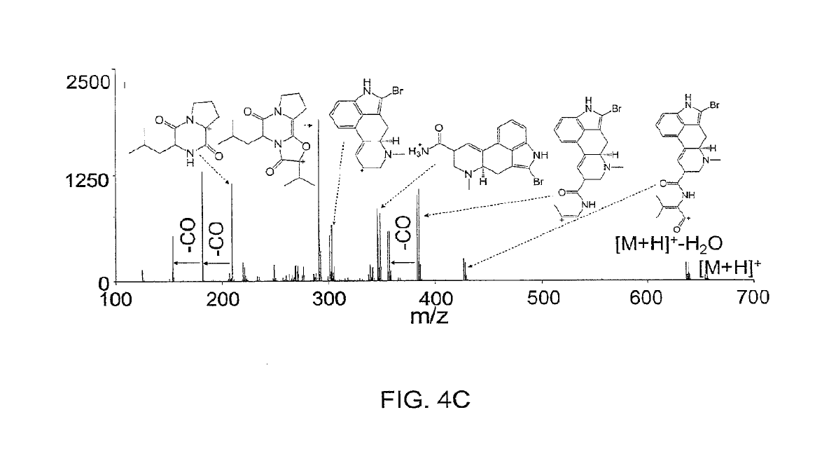

Experiments were also performed on a small drug model, bromocriptine. Bromocriptine is a dopamine agonist used in the treatment of a variety of conditions, including the presence of pituitary tumors (CAS #25614-03-3). Protonated bromocriptine ions over a window of m/z values of 653-656 (to allow for both bromine isotopes to be present in the precursor ion population) were transmitted through Q1 and subjected to three variations of collisional activation, as reflected in the product ion spectra of FIG. 4.

FIG. 4A shows the ion trap DDC product ion spectrum using V_{DDC}=40 V and V_{RF}=611 V, which shows several high mass products ions that contain the bromine substitution, as reflected in the isotope pattern, as well as an abundant product at m/z 291 that is consistent with a third generation product that follows from consecutive losses of water and HBr.

The DDC CID appears to fragment the ion sequentially along the ion, and water loss may also be followed by consecutive cleavages to yield the ions at m/z 346/348, and one or the other of the of ions may be used in single reaction monitoring LC/MS/MS assays.

FIG. 4B shows the product ion spectrum of protonated bromocriptine obtained after conventional AC ion trap collisional activation with a supplementary AC at 500 mVₚ₋ₚ, for 7.5 ms, and a trapping well depth of 12.37 V so as to directly compare AC CID to DDC CID. While both spectra show the same major fragments, the AC CID experiment is dominated by the major first generation cleavage that results in water loss while the DDC experiment yields substantially greater sequential cleavage.

FIG. 4C shows the transmission-mode DDC CID results using V_{DDC}=28 V and V_{RF}=611 V. The transmission-mode DDC results here are similar to the ion trap DDC results. As in the leucine enkephalin experiment described above, no measurable loss in total ion signal was noted when the DDC was applied.

A larger fraction of precursor ions appeared to undergo dissociation in the transmission-mode experiment than in the ion-trap experiment despite the lower V_{DDC} and, presumably, the shorter residence time in the collision cell of the former experiment. This may result from a contribution from collisional activation associated with injection into the collision cell in the transmission mode experiment. While no significant CID was noted before application of the V_{DDC}, there may be some collisional activation of the ions that may contribute to the dissociation rate when the V_{DDC} is applied. Further examination of the transmission mode DDC experiment could be performed to determine the extent to which the two forms of collisional activation (viz., beam-type collisional activation and DDC collisional activation) might be used together.

In this disclosure a method of operating a multi-stage linear ion trap has been described, including the steps of injecting ions into a first quadrupole stage where mass selection may be performed. The mass selected ions may be injected into a second quadrupole stage, operating in a transmission mode. A first opposing pair of rods of the second quadrupole stage is operated so as to have a first DC potential difference therebetween and a second opposing pair of rods of the second quadrupole state is operated so as to have a second DC potential difference therebetween. The ions from the second quadrupole stage are injected into another device which may be a mass spectrometer or a further processing step. The first pair of rods may be operated at a zero voltage difference, and the second pair of rods may be operated at a selected voltage difference.

The method of may include operating a quadrupole stage disposed between an ion source and the first quadrupole stage in a transmission mode where an opposing pair opposing pair of rods of the quadrupole stage are operated at a DC potential difference.

Another quadrupole ion trap or other processing stage may disposed following the second ion trap. The another quadrupole trap may be operated in a transmission mode. The DC voltages applied to the rods of the another quadrupole tram may be such that the motion of the ions in the trap are substantially along the axis of the device.

A variety of other processing stages may follow the second quadrupole stage including further quadrupole processing stages, mass analyzers, which may be time-of-flight mass spectrometers, or the like.

It is intended that the foregoing detailed description be regarded as illustrative rather than limiting, and that it be understood that it is the following claims, including all equivalents, that are intended to define the spirit and scope of this invention.

What is claimed is:

1. A method of operating a multi-stage linear ion trap, comprising:
injecting ions into a first quadrupole stage;
mass-selecting ions for analysis in the first quadrupole stage; and
injecting the mass-selected ions into a second quadrupole stage,
wherein the second quadrupole stage is operated in a transmission mode having an opposing pair of rods of the two pairs of rods of the second quadrupole stage operated at a DC potential difference so as to cause ions to be displaced from the second quadrupole stage axis of symmetry; and
injecting ions from the second quadrupole stage into a mass analyzer

2. The method of claim 1, further comprising operating a quadrupole stage disposed between an ion source and the first quadrupole stage in a transmission mode having an opposing pair of rods of the quadrupole stage operated at a DC potential difference.

3. The method of claim 1 or 2, further comprising operating an ion trap disposed between the second ion trap and the mass analyzer in a transmission mode.

4. The method of claim 1, 2, or 3, wherein each stage of the multi-stage linear ion trap is operated in a transmission mode.

5. The method of claim 1, 2, 3, or 4, wherein the mass analyzer is a time-of-flight mass analyzer.

6. The method of claim 1, wherein a first pair of rods of the opposing pair of rods of the second quadrupole stage is maintained at a first DC potential difference and a second pair of rods of the opposing pair of rods of the second quadrupole stage is operated at a second DC potential difference.

7. The method of claim 6, where the first DC potential difference is zero.

8. The method of claim 6, wherein the first pair of rods are operated from a first DC power supply, and the second pair of rods are operated using a separate power supply for each rod of the second pair of rods.
